(19) United States
(12) Patent Application Publication
(10) Pub. No.: US 2021/0213856 A1
(43) Pub. Date: Jul. 15, 2021

(54) SEAT HEATER

(71) Applicant: DENSO CORPORATION, Kariya-city (JP)

(72) Inventors: Takahisa FUJII, Kariya-city (JP); Shuji ITO, Kariya-city (JP); Kimitake ISHIKAWA, Kariya-city (JP); Yusuke TANAKA, Kariya-city (JP)

(21) Appl. No.: 17/217,498

(22) Filed: Mar. 30, 2021

Related U.S. Application Data
(63) Continuation of application No. PCT/JP2019/036773, filed on Sep. 19, 2019.

(30) Foreign Application Priority Data
Oct. 9, 2018 (JP) 2018-191137

(51) Int. Cl. B60N 2/56; H05B 1/02

(52) U.S. Cl. CPC B60N 2/5685; H05B 2203/029; H05B 1/0238

(57) ABSTRACT

A seat heater is configured to heat a passenger seated on a seat disposed in a vehicle. The seat heater includes is a radiant heater that is disposed in an area of the seat that is not in contact with the passenger seated on the seat and configured to radiant heat toward the passenger seated on the seat. The seat includes a seatback configured to support a back of the passenger. The seatback has linear lateral hanging portions extending in a width direction of the vehicle. The radiant heater is disposed above the most upper one of the plurality of liner lateral hanging portions in a vertical direction of the vehicle.

### CROSS REFERENCE TO RELATED APPLICATION

The present application is a continuation application of International Patent Application No. PCT/JP2019/036773 filed on Sep. 19, 2019, which designated the U.S. and claims the benefit of priority from Japanese Patent Application No. 2018-191137 filed on Oct. 9, 2018. The entire disclosures of all of the above applications are incorporated herein by reference.

### TECHNICAL FIELD

The present disclosure relates to a seat heater.

### BACKGROUND ART

A seat heater is configured to make a passenger in a vehicle feel warm by a thermal conduction through a contact portion between the passenger and a seat of the vehicle heated by a lead wire and the like.

### SUMMARY

A seat heater is configured to heat a passenger seated on a seat disposed in a vehicle. The seat heater includes a radiant heater configured to radiate a radiant heat toward the passenger seated on the seat. The radiant heater is disposed in an area of the seat that is not in contact with the passenger seated on the seat.

### BRIEF DESCRIPTION OF THE DRAWINGS

FIG. 1 is a diagram illustrating an overall configuration of a seat heater according to a first embodiment.

FIG. 2 is a diagram illustrating a state where a passenger is seated on a seat of the seat heater of the first embodiment.

FIG. 3 is a schematic cross-sectional view of the seat heater.

FIG. 4 is a diagram illustrating a surface of a protecting member.

FIG. 5 is a diagram illustrating arrangement positions of radiant heaters.

FIG. 6 is a diagram illustrating an overall configuration of a seat heater according to a second embodiment.

FIG. 7 is a diagram illustrating an overall configuration of a seat heater according to a third embodiment.

FIG. 8 is a block diagram of the seat heater of the third embodiment.

FIG. 9 is a flowchart of the seat heater of the third embodiment.

FIG. 10 is a diagram illustrating output characteristics of a thermal conductive heater and a radiant heater of the third embodiment.

FIG. 11 is a block diagram of a seat heater according to a fourth embodiment.

FIG. 12 is a flowchart of the seat heater of the fourth embodiment.

FIG. 13 is a diagram illustrating an output characteristic of a radiant heater of the seat heater of the fourth embodiment.

FIG. 14 is a diagram illustrating a configuration of a seat heater according to a fifth embodiment and illustrating both a state where a seatback of the seat is not reclined and a state where the seatback is reclined.

FIG. 15 is a block diagram of the seat heater of the fifth embodiment.

FIG. 16 is a flowchart of the seat heater of the fifth embodiment.

FIG. 17 is a diagram illustrating an output characteristic of a radiant heater of the seat heater of the fifth embodiment.

FIG. 18 is a diagram illustrating a seat heater according to a sixth embodiment.

FIG. 19 is a diagram illustrating power consumption of radiant heaters disposed in seats of the seat heater of the sixth embodiment.

### DETAILED DESCRIPTION OF EMBODIMENTS

To begin with, examples of relevant techniques will be described.

A seat heater is configured to estimate a temperature of a portion of a seat in contact with a passenger and control an output of a heater such that the estimated temperature is close to a predetermined target temperature. The seat heater is configured to make the passenger feel warm by a thermal conduction through a contact portion between the passenger and the seat heated by a lead wire and the like.

By the way, according to a study of inventors of the present disclosure, the entire of an upper body of the passenger is not in contact with the seat and an upper portion of the back of the passenger is apart from the seat when the passenger is seated on the seat. Thus, in the configuration of the device, a portion of the passenger apart from the seat cannot be sufficiently heated. Another device is configured to send a temperature-controlled airflow toward the passenger by a blower disposed in a seat. However, according to a study of the inventors of the present disclosure, by using this device, the airflow hits the passenger, so that the passenger feels bothered.

It is objective of the present disclosure to sufficiently heat a portion of a passenger apart from a seat without bothering the passenger.

According to an aspect of the present disclosure, a seat heater is configured to heat a passenger seated on a seat disposed in a vehicle. The seat heater includes a radiant heater configured to radiate a radiant heat toward the passenger seated on the seat. The radiant heater is disposed in an area of the seat that is not in contact with the passenger seated on the seat.

According to the above-described configuration, the radiant heater disposed in the area of the seat that is not in contact with the passenger seated on the seat is configured to radiate a radiant heat toward the passenger seated on the seat. Thus, a portion of the passenger that is not in contact with the seat can be sufficiently heated without annoying the passenger.

Hereinafter, embodiments of the present disclosure will be described, with reference to the drawings. In the following embodiments, the same reference numeral is given to the same or equivalent parts in the drawings.

### First Embodiment

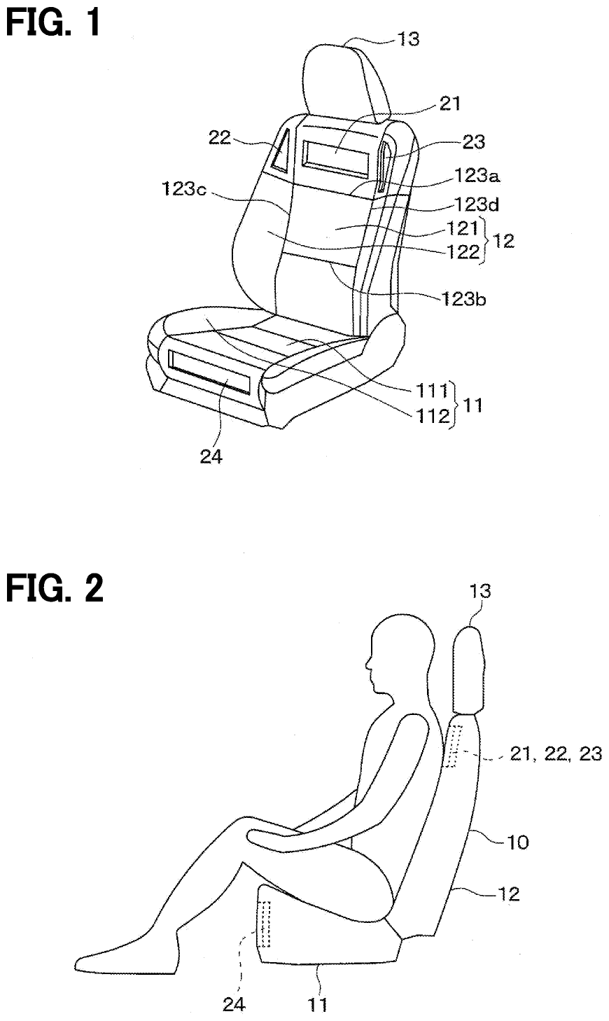

A seat heater according to a first embodiment will be described with reference to FIGS. 1 to 5. As shown in FIGS. 1, 2 and 5, the seat heater of this embodiment is disposed in a seat 10 mounted in an automobile. The seat 10 includes a seat cushion 11, a seatback 12, and a headrest 13. Each of the seat cushion 11, the seatback 12, and the headrest 13 are configured such that a pad material 10a made of a cushion material such as urethane foam is covered by a skin material such as synthetic leather and a cloth.

The seat cushion 11 includes a seat surface portion 111 and extending portions 112. The seat surface portion 111 are contact with buttocks and thighs of a passenger from a lower side of the passenger to support the buttocks and the thighs. The extending portions 112 extend outward from the seat surface portion 111 in a lateral direction to support sides of the buttocks and the thighs of the passenger.

The seatback 12 includes a seat back portion 121 supporting an entire of a back of the passenger and side supports 122 supporting the passenger from sides of the passenger in the lateral direction. The seat back portion 121 extends upward from a rear end of the seat surface portion 111 in an up-down direction. The side supports extend from the both ends of the seat back portion 121 in the lateral direction.

The seatback 12 of the seat 10 of this embodiment includes multiple hanging portions 123a to 123d to restrict the skin material of the seatback 12 from twisting.

The hanging portions 123a and 123b extend in the seat back portion 121 in the lateral direction. The hanging portion 123a is located above a center of the seat back portion 121 in a vertical direction and the hanging portion 123b is located below the center of the seat back portion 121 in the vertical direction.

The hanging portions 123c and 123d extend in the seat back portion 121 in the up-down direction. The hanging portion 123c is located in a right side portion from a center of the seat back portion 121 in the lateral direction and the hanging portion 123d is located in a left side portion from the center of the seat back portion 121 in the lateral direction.

The hanging portions 123a and 123b correspond to lateral hanging portions and the hanging portions 123c and 123d correspond to longitudinal hanging portions.

The headrest 13 is configured to support the back of the head of the passenger. The headrest 13 is disposed in an upper end of the seatback 12. The headrest 13 has a width in the lateral direction that is shorter than a width of the seatback 12 in the lateral direction.

In the seat 10, radiant heaters 21 to 24 configured to radiate a radiant heat toward the passenger are disposed. The radiant heat is a heat that is directly transmitted by a heat of far infrared rays. The radiant heaters 21 to 24 are disposed in areas of the seat 10 that are not easily in contact with the passenger seated on the seat 10. That is, the radiant heaters 21 to 24 are disposed in the areas that are not in contact with the passenger.

The radiant heater 21 is disposed above the center of the seat back portion 121 in the vertical direction. That is, the radiant heater 21 is disposed above the hanging portion 123a that is disposed above the center of the seat back portion 121 in the vertical direction.

The radiant heaters 22 and 23 are disposed above a center in the vertical direction of side supports 122 that are disposed in a right portion and a left portion of the seat. That is, the radiant heaters 22 and 23 are disposed above the hanging portion 123a that is disposed above the center of the side supports 122 in the vertical direction.

The radiant heater 24 is disposed in a front side surface of the seat surface portion 111. The radiant heater 24 is configured to radiate a radiant heat toward calves of the passenger. The heating temperature of each of the radiant heaters 22 to 24 is about 90° C. to 100° C.

The radiant heaters 21 to 24 are exposed toward the passenger seated on the seat 10.

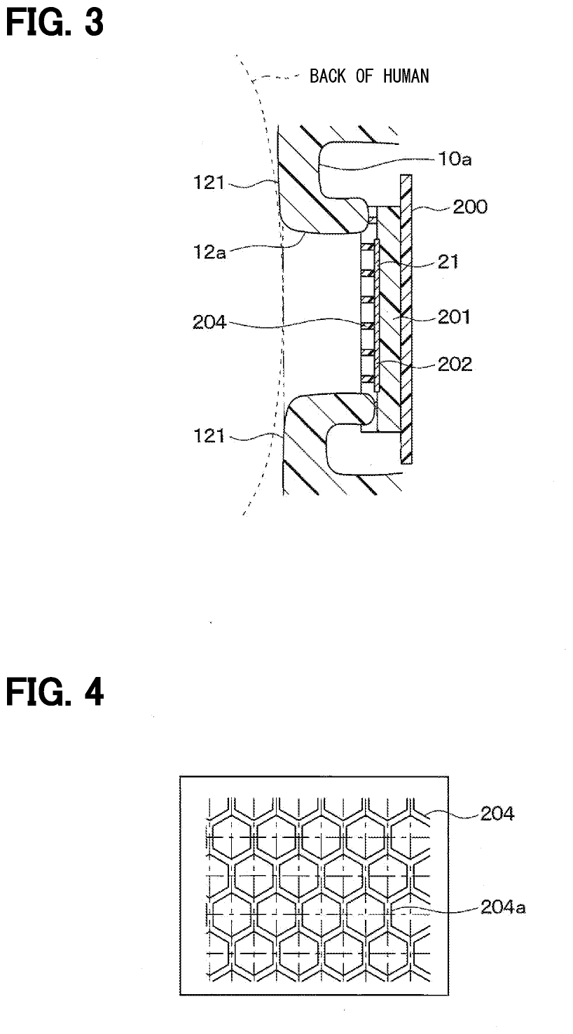

FIG. 3 is a cross-sectional view of the seat back portion 121 in which the radiant heater 21 is disposed. As shown in the drawing, the seatback 12 of the seat 10 has a recessed portion 12a recessed from a front surface of the seatback 12 in a thickness direction of the seatback 12, i.e., toward a rear side of the vehicle. The recessed portion 12a is formed above the uppermost lateral hanging portion 123a that is disposed above the center of the seatback 12 in the vertical direction. The radiant heater 21 is located in a portion recessed from the surface of the seat 10 that is defined by the recessed portion 12a.

The radiant heater 21 includes a support substrate 200, a heat insulating member 201, a heat generating portion 202, and a protecting member 204.

The support substrate 200 is fixed inside the seat back portion 121. The support substrate 200 is formed into a thin plate shape having a substantially rectangular shape. The heat generating portion 202 that has a plate shape is disposed on a front side of the support substrate 200 and the heat insulating member 201 having an excellent heat insulating property is disposed between the support substrate 200 and the heat generating portion 202.

The heat generating portion 202 is configured to generate heat when being energized. The heat generating portion 202 is configured to radiate a radiant heat that makes the passenger feel warm.

The protecting member 204 that has an insulating property is disposed on a front surface of the heat generating portion 202. As shown in FIG. 4, the protecting member 204 defines through holes 204a arranged in a honeycomb shape. The radiant heat radiated by the heat generating portion 202 reaches the passenger through the through holes 204a of the protecting member 204. The protecting member 204 protects the heat generating portion 202.

The cross-sectional structure of the seat back portion 121 in which the radiant heater 21 is disposed is described with reference to FIG. 3. Other radiant heaters 22 to 24 have similar structures as shown in FIG. 3. The radiant heaters 22 and 24 are disposed in portions recessed from a surface of the seat 10.

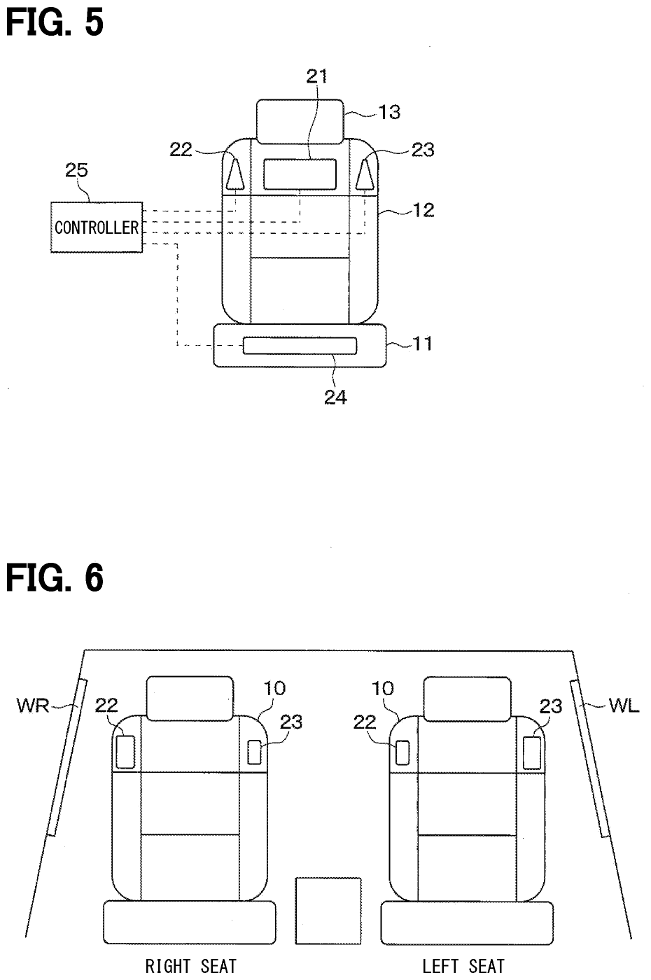

As shown in FIG. 5, a controller 25 is connected to the radiant heaters 21 to 24 of this embodiment. The controller 25 is connected to a battery of the vehicle. Each of the radiant heaters 21 to 24 is configured to generate a heat when being energized by the controller 25 and to radiate a radiant heat. The controller 25 may be a microcomputer operated by executing a program or may be an exclusive hardware.

The right side support 122 in which the radiant heater 22 is disposed and the left side support 122 in which the radiant heater 23 is disposed are located outside of the headrest 13 in the width direction. That is, the radiant heater 22 and the radiant heater 23 are disposed outside of the headrest 13 in the width direction.

Next, an operation of the seat heater will be described. When an ignition switch of the vehicle is turned on, the controller 25 starts to energize the radiant heaters 21 to 24.

The radiant heaters 21 to 24 generate heat when being energized by the controller 25 and radiate radiant heats toward the passenger. Thereby, an area of the passenger that is not in contact with the seat 10 can be sufficiently heated.

As described above, the seat heater of this embodiment is configured to heat the passenger seated on the seat 10 disposed in the vehicle. The seat heater includes the radiant heaters 21 to 24 that are disposed in the areas of the seat 10 that are not in contact with the passenger seated on the seat 10. The radiant heaters 21 to 24 are configured to radiate radiant heats toward the passenger seated on the seat 10.

According to the above-described configuration, the radiant heaters 21 to 24 are disposed in the areas of the seat 10 that are contactless with the passenger seated on the seat 10 and radiate radiant heats toward the passenger seated on the seat 10. Thus, an area of the passenger that is not in contact with the seat 10 can be sufficiently heated without annoying the passenger.

The seat 10 has the recessed portion 12a recessed from the surface of the seat 10. Each of the radiant heaters 21 to 24 is disposed in a portion recessed from the surface of the seat 10 defined by the recessed portion 12a.

The radiant heaters 21 to 24 are exposed toward the passenger seated on the seat 10. Thus, the radiant heats radiated by the radiant heaters 21 to 24 can efficiently reach the passenger.

The seat 10 includes the headrest 13 configured to support the back of the head of the passenger. The radiant heaters 21 to 24 are disposed in the area of the seat 10 located outside of the headrest 13 in the width direction.

As described above, the radiant heaters 21 to 24 can be arranged in the area of the seat 10 outside of the end portions of the headrest 13 in the width direction. Thereby, the passenger can be heated in the lateral direction.

The seat 10 includes the seatback 12 configured to support the back of the passenger. The seatback 12 includes the linear lateral hanging portions 123a and 123b extending in the width direction of the vehicle. The radiant heaters 21 and 24 are disposed above the uppermost lateral hanging portion 123a of the multiple lateral hanging portions 123a and 123b.

As described above, the radiant heaters 21 to 24 can be arranged above the uppermost lateral hanging portion 123a of the multiple lateral hanging portions 123a and 123b in the vertical direction. In addition, this configuration restricts shoulders of the passenger from easily touching the radiant heater 21 and an upper portion of the back of the passenger can be heated. Further, a blood flow between the neck and the shoulders of the passenger is expected to be improved.

The seatback 12 has the linear longitudinal hanging portions 123c and 123d extending in the up-down direction. The radiant heaters 21 to 24 are disposed in areas outside of the multiple longitudinal hanging portions 123c and 123d in the width direction.

As described above, the radiant heaters are disposed in the area outside of the multiple longitudinal hanging portions 123c and 123d in the width direction. Thereby, the passenger can be heated in the lateral direction.

The seat heater includes the multiple radiant heaters 21 to 24 in different positions of the seat 10. As described above, the multiple radiant heaters 21 to 24 can be disposed in different positions of the seat 10. Thereby, the passenger can be heated in various directions.

### Second Embodiment

A configuration of a seat heater of a second embodiment will be described with reference to FIG. 6. FIG. 6 is a view of a right seat 10 and a left seat 10 viewed form a front side of the vehicle. In the first embodiment, the seat 10 includes the radiant heaters 21 to 24. In this embodiment, each of the seats 10 includes the radiant heaters 22 and 23. In this embodiment, the radiant heater 22 has the heat generating portion 202 having a size different from that of the heat generating portion 202 of the radiant heater 23.

The right seat 10 is disposed in a right side portion of the vehicle. The right seat 10 includes the radiant heater 22 and the radiant heater 23. A distance between a right window WR and the radiant heater 22 is short and a distance between the right window WR and the radiant heater 23 is long. The heat generating portion 202 of the radiant heater 22 has an area larger than that of the heat generating portion 202 of the radiant heater 23.

That is, the area of the heat generating portion 202 of the radiant heater 22 that a cold air is likely to reach from the right window WR is larger than the area of the heat generating portion 202 of the radiant heater 23. Thereby, the radiant heater 22 having a short distance from the right window WR radiates a strong radiant heat in a wide area, which reduces a discomfort of the passenger seated on the right seat due to the cold air from the right window.

In addition, an output of the radiant heater 22 that the cold air is likely to reach from the right window WR is set to a value larger than an output of the radiant heater 23. Thus, the radiant heater 22 having a short distance from the right window WR radiates a strong radiant heat, thereby reducing the discomfort of the passenger seated on the right seat due to the cold air from the right window.

On the other hand, the left seat 10 is disposed in a left side portion of the vehicle. The left seat 10 includes the radiant heater 22 and the radiant heater 23. A distance between the radiant heater 23 and a left window WL is short and a distance between the radiant heater 22 and the left window WL is long. The heat generating portion 202 of the radiant heater 23 has an area greater than that of the heat generating portion 202 of the radiant heater 22.

That is, the heat generating portion 202 of the radiant heater 23 that a cold air is likely to reach from the left window WL has the area greater than the area of the heat generating portion 202 of the radiant heater 22. Thus, the radiant heater 23 having a short distance from the left window WL radiates a strong radiant heat in a wide range, which reduces a discomfort of the passenger seated on the left seat due to the cold air from the left window WL.

In addition, an output of the radiant heater 23 that the cold air is likely to reach from the left window WL is set to a value larger than an output of the radiant heater 22. Thus, the radiant heater 23 having a short distance from the left window WL radiates a strong radiant heat, thereby reducing the discomfort of the passenger seated on the left seat due to the cold air from the left window WL.

The present embodiment can achieve the effects and advantages, which are obtained from the structure common to the first embodiment.

In this embodiment, the right seat 10 disposed near the right window WR of the vehicle includes the radiant heater disposed in a right side portion of the right seat in the width direction and the radiant heater disposed in a left side portion of the right seat 10 in the width direction.

In the multiple radiant heaters, the radiant heater disposed near the right window is configured to consume power greater than that of the left radiant heater disposed near the center of the vehicle in the width direction.

Therefore, even if the cold air enters into the vehicle through the right window, the passenger can be efficiently heated.

In this embodiment, the left seat 10 disposed near the left window WL includes the radiant heater disposed in a left side portion of the seat 10 in the width direction and the radiant heater disposed in a right side portion of the seat 10 in the width direction.

In the multiple radiant heaters, the radiant heater disposed in the left side portion of the seat in the width direction is configured to consume power greater than that of the radiant heater disposed in the right side portion of the seat in the width direction.

Thus, even if the cold air enters into the vehicle through the left window, the passenger can be efficiently heated.

In this embodiment, the heat generating portion 202 of the radiant heater 23 that has a short distance from the left window WL has an area larger than that of the heat generating portion 202 of the radiant heater 22 that has a long distance from the left window WL. Further, the radiant heaters are controlled such that the radiant heater near the right or left window consumes power greater than that of the radiant heater near the center of the vehicle in the width direction.

In contrast, the radiant heaters may be configured such that a linear density of the radiant heater disposed near the right or the left window is larger than that of the radiant heater disposed near the center of the vehicle in the width direction. The radiant heaters may be configured such that a wire diameter of the radiant heater disposed near the right or the left window is larger than a wire diameter of the radiant heater disposed near the center of the vehicle in the width direction.

### Third Embodiment

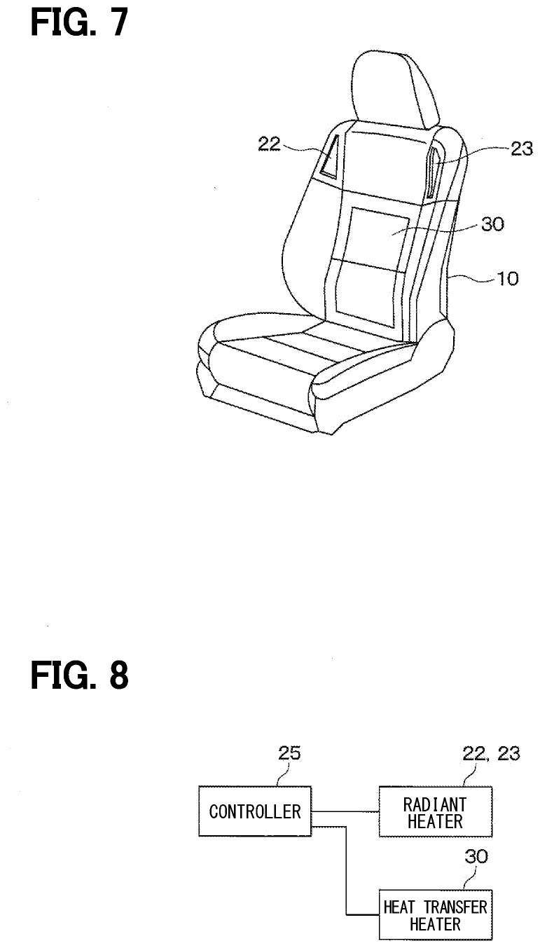

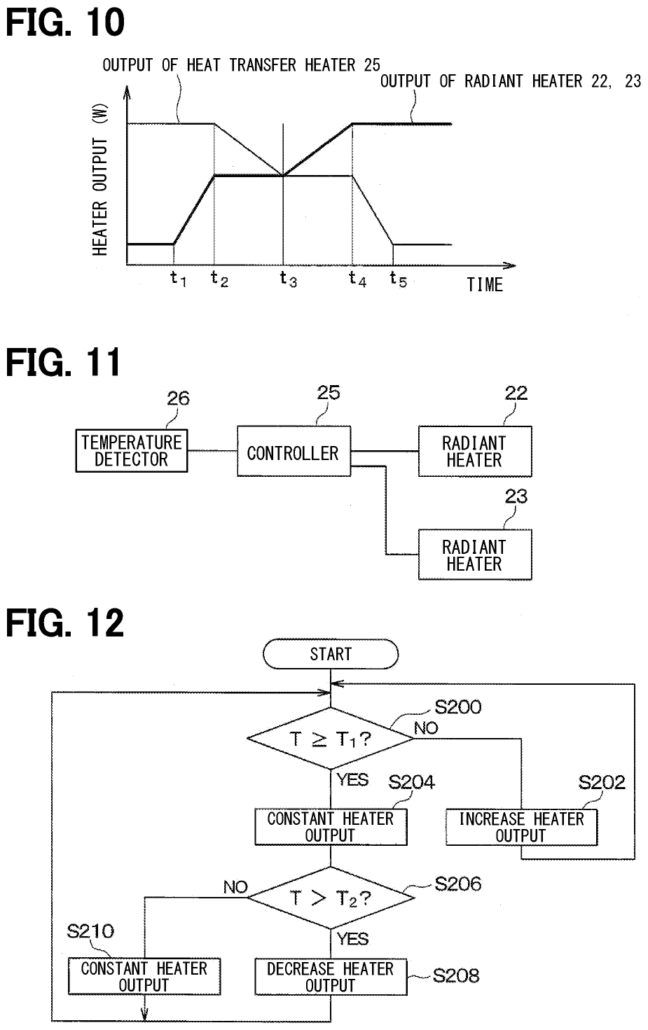

A seat heater of a third embodiment will be described with reference to FIGS. 7 to 10. As shown in FIG. 7, the seat heater of the present embodiment includes a heat transfer heater 30 in addition to the radiant heaters 22 and 23. The heat transfer heater 30 is configured to warm the passenger by a heat transfer through a contact portion between the passenger and the seat 10 heated by a wire. The heat transfer heater 30 is embedded inside the seatback 12. As shown in FIG. 8, the radiant heaters 22 and 23 and the heat transfer heater 30 are connected to the controller 25. The radiant heaters 22 and 23 and the heat transfer heater 30 are configured to generate heat when being energized by the controller 25. The heating temperature of the radiant heaters 22 and 23 is around 90° C. to 100° C. while the heating temperature of the heat transfer heater 30 is around 40° C. to 50° C.

However, when the output of the radiant heaters 22 and 23 and the output of the heat transfer heater 30 are always controlled to be the maximum value, not only the power consumption of the radiant heaters 22 and 23 and the heat transfer heater 30 becomes large, but also a load of the battery that supplies electricity to the radiant heaters 22 and 23 and the heat transfer heater 30 becomes large.

Thus, the controller 25 of the present embodiment performs a process to vary the output of the heat transfer heater 30 and the radiant heaters 22 and 23 in accordance with a period of time after starting an operation.

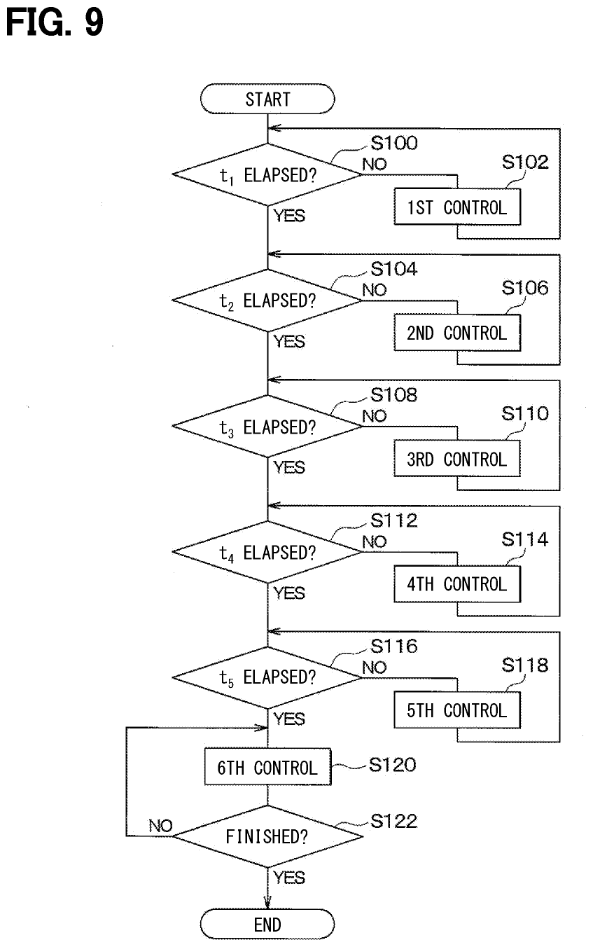

FIG. 9 is a flowchart of this process. The controller 25 executes the process shown in FIG. 9 after the seat heater starts the operation.

At first, the controller 25 determines whether time t1 has elapsed since the seat heater started the operation. When the controller 25 determines that time t2 has not elapsed since the seat heater started the operation, the controller 25 executes a first control at S102. In the first control, the output of the radiant heaters 22 and 23 are controlled to a first value that is relatively small and the output of the heat transfer heater 30 is controlled to a second value that is larger than the first value.

Next, when the time t1 has elapsed, the controller 25 determines at S104 whether time t2 has elapsed since the seat heater started the operation. When the controller 25 determines that time t2 has not elapsed since the seat heater started the operation, the controller 25 executes a second control at S106.

In the second control, the output of the radiant heaters 22 and 23 are gradually increased from the first value and the output of the heat transfer heater 30 is maintained at the second value.

Next, after the time t2 has elapsed since the operation was started, the controller determines at S108 whether time t3 has elapsed since the seat heater started the operation. When the time t3 has not elapsed after the seat heater started the operation, the controller 25 executes a third control at S110.

In the third control, the output of the radiant heaters 22 and 23 are maintained at a constant value and the output of the heat transfer heater 30 is gradually decreased.

Next, when the time t3 has elapsed since the operation started, the controller 25 determines at S112 whether time t4 has elapsed since the seat heater started the operation. When the time t4 has not elapsed since the seat heater started the operation, the controller 25 executes a fourth control at S114.

In the fourth control, the output of the radiant heaters 22 and 23 are gradually increased and the output of the heat transfer heater 30 is maintained at a constant value.

Next, when the time t4 has elapsed since the operation started, the controller 25 determines at S116 whether time t5 has elapsed since the seat heater started the operation. When the time t5 has not elapsed since the seat heater started the operation, the controller 25 executes a fifth control at S118.

In the fifth control, the output of the radiant heaters 22 and 23 is maintained at a constant value and the output of the heat transfer heater 30 is gradually decreased.

Next, when the time t5 has elapsed since the operation started, the controller 25 executes a sixth control at S120.

In the sixth control, the output of the radiant heaters 22 and 23 is maintained at a constant value and the output of the heat transfer heater 30 is maintained at a constant value.

Next, the controller 25 determines whether to finish the control or not at S122 based on whether the passenger performs an operation to instruct an end of the control. When the passenger does not perform the operation to instruct the end of the control, the control is returned to S120. When the passenger performs the operation to instruct the end of the control, the controller 25 terminates this process.

As a result, not only the power consumption of the entire device can be reduced, but also the power consumption of the radiant heaters 22 and 23 and the power consumption of the heat transfer heater 30 can be uniform. Thus, the load of the battery can be reduced.

The present embodiment can achieve the effects and advantages, which are obtained from the structure common to the first embodiment.

The seat heater of the present embodiment includes a heat transfer heater 30 as a heating element and a controller 25. The heat transfer heater 30 is configured to heat the passenger in a heating manner that is different from a heating manner of the radiant heater. The controller 25 is configured to control the heat transfer heater 30 and the radiant heaters 22 and 23.

The controller 25 is configured to control the radiant heaters 22 and 23 to operate with a power consumption lower than that of the heat transfer heater 30 for a predetermined period after starting an operation of the radiant heaters 22 and 23 and the heat transfer heater 30 (i.e., a period just before t3 time). After that, the controller is configured to control the heat transfer heater 30 to operate with a power consumption lower than that of the radiant heaters 22 and 23.

Thus, the power consumption of the radiant heaters 22 and 23 and the power consumption of the heat transfer heater 30 can be uniform and the power can be saved. In addition, the load of the power that supplies electricity to the radiant heaters 22 and 23 and the heat transfer heater 30 can be suppressed.

In this embodiment, the heat transfer heater 30 is described as the heating element configured to heat the passenger in the heating manner that is different from the heating manner of the radiant heater. In contrast, the heating element may be a blowing device configured to send a temperature-controlled airflow toward the passenger from a blower disposed in the seat.

### Fourth Embodiment

A seat heater of a fourth embodiment will be described with reference to FIGS. 11 to 13. The seat heater of the present embodiment is different from the seat heater of the third embodiment in that the seat heater of the present embodiment does not include the heat transfer heater 30. In addition, the controller 25 of the seat heater of the present embodiment is configured to input signals indicating the temperature in the vehicle cabin from an inside temperature detector 26 configured to detect the temperature in the vehicle cabin. The inside temperature detector 26 is configured with a temperature sensor disposed in the vehicle cabin.

FIG. 12 is a flowchart of the controller 25 of this embodiment. The controller 25 executes the process shown in FIG. 12 after the seat heater starts an operation.

At first, the controller 25 determines whether the temperature in the vehicle cabin is equal to or greater than a first threshold T1 at S200. Specifically, the controller 25 determines whether the temperature in the vehicle cabin is equal to or greater than the first threshold T1 by specifying the temperature in the vehicle cabin based on the signals input from the inside temperature detector 26. When the temperature in the vehicle cabin is less than the first threshold T1, the controller 25 gradually increases the output of the radiant heaters 22 and 23 at S202.

When the temperature in the vehicle cabin is equal to or greater than the first threshold T1, the controller 25 determines whether the temperature in the vehicle cabin is greater than a second threshold T2 that is greater than the first threshold T1 at S206.

When the temperature in the vehicle cabin is less than the second threshold T2, the controller 25 maintains the output of the radiant heaters 22 and 23 at a constant value at S204.

When the temperature in the vehicle cabin is greater than the second threshold T2, the controller 25 decreases the output of the radiant heaters 22 and 23 at S208. When the temperature in the vehicle cabin is equal to or greater than the first threshold T1 and less than the second threshold T2, the controller 25 maintains the output of the radiant heaters 22 and 23 at a constant value at S210.

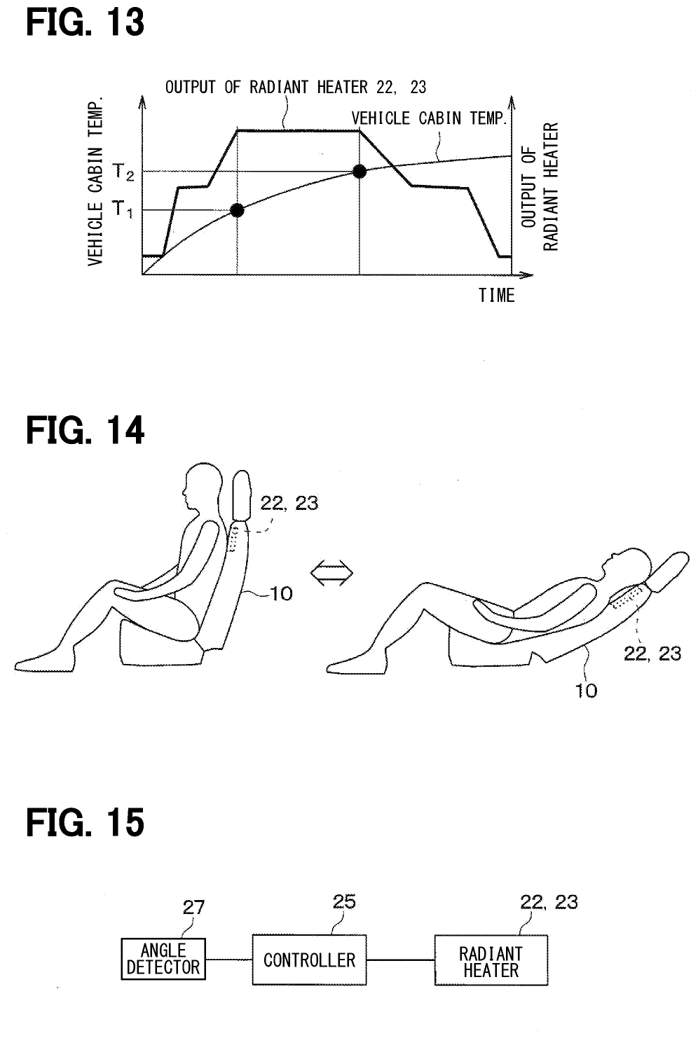

As described above, as the temperature in the vehicle cabin detected by the inside temperature detector 26 increases, the power consumption of the radiant heaters 22 and 23 can be suppressed. For example, as shown in FIG. 13, when the temperature in the vehicle cabin is less than the first threshold T1, the output of the radiant heaters 22 and 23 are gradually increased. When the temperature in the vehicle cabin is equal to or greater than the first threshold T1 and less than the second threshold T2, the output of the radiant heaters 22 and 23 is maintained at a constant value. When the temperature in the vehicle cabin is higher than the second threshold T2, the output of the radiant heaters 22 and 23 is gradually decreased.

The present embodiment can achieve the effects and advantages, which are obtained from the structure common to the first embodiment.

The seat heater of this embodiment includes the inside temperature detector 26 configured to detect the temperature in the vehicle cabin and the controller 25 configured to control the radiant heaters 22 and 23. The controller 25 is configured to suppress the power consumption of the radiant heaters 22 and 23 as the temperature in the vehicle cabin detected by the inside temperature detector 26 increases. Therefore, unnecessary power consumption can be avoided.

### Fifth Embodiment

A seat heater of a fifth embodiment will be described with reference to FIGS. 14 to 16. As shown in FIG. 14, the seat heater of the present embodiment is configured to vary the output of the radiant heaters 22 and 23 in accordance with a reclining angle of the seatback 12 of the seat 10 when the seatback 12 is reclined. As shown in FIG. 15, the controller 25 of the present embodiment is configured to input signals indicating an angle of the seatback 12 from an angle detector 27 configured to detect the reclining angle that is an inclination angle of the seatback 12.

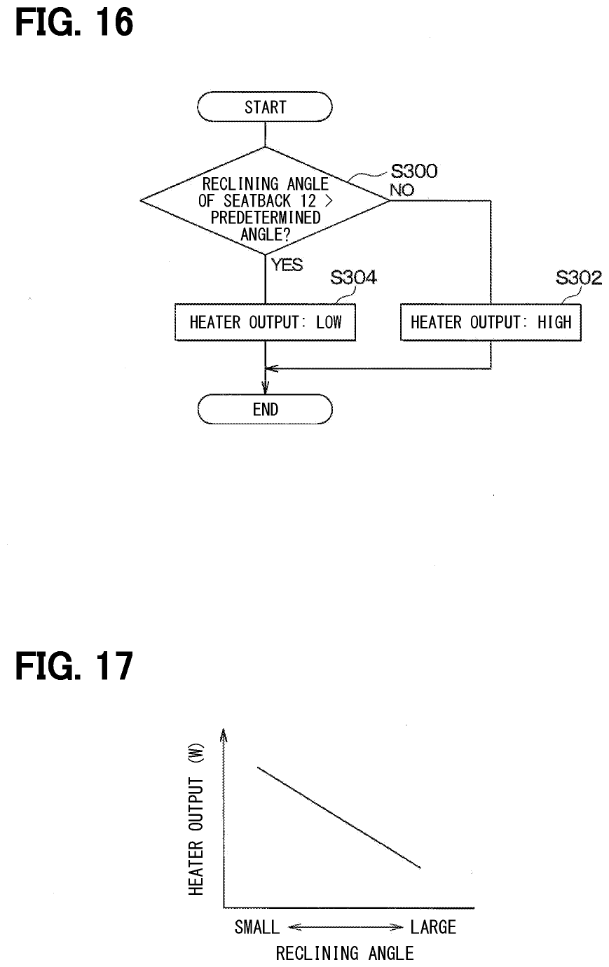

FIG. 16 is a flowchart of the controller 25 of the present embodiment. The controller 25 executes the process shown in FIG. 16 after the seat heater starts an operation.

At first, the controller 25 determines whether the reclining angle of the seatback 12 is greater than a predetermined angle or not at S300. As the reclining angle of the seatback 12 increases, a posture of the passenger becomes close to a posture of the passenger lying down.

When the reclining angle of the seatback 12 is equal to or greater than the predetermined angle, the controller 25 controls the heater output at a low level at S304 and terminates this process. When the reclining angle of the seatback 12 is less than the predetermined angle, the controller 25 controls the heater output at a high level at S302 and terminates this process.

The present embodiment can achieve the effects and advantages, which are obtained from the structure common to the first embodiment.

The seat heater of this embodiment includes the angle detector 27 configured to detect the reclining angle of the seatback and the controller 25 configured to control the radiant heater. The radiant heater is disposed in the seatback. The controller is configured to suppress the power consumption of the radiant heater upon determining the reclining angle of the seatback detected by the angle detector is greater than the predetermined angle.

When the reclining angle of the seatback is large, a distance between the passenger and the radiant heater is likely to be short and the passenger may feel an excessive heat.

However, as described above, the controller 25 is configured to suppress the power consumption of the radiant heater upon determining the reclining angle of the seatback detected by the angle detector is greater than the predetermined angle.

Thus, when the reclining angle of the seatback is large, the passenger is restricted from feeling an excessive heat. In addition, unnecessary power consumption of the radiant heater can be avoided.

In this embodiment, when the controller 25 determines that the reclining angle of the seatback detected by the angle detector 27 is greater than the predetermined angle, the power consumption of the radiant heater is restricted. In addition, as shown in FIG. 17, the power consumption of the radiant heater may be continuously changed according to the reclining angle of the seatback detected by the angle detector 27.

### Sixth Embodiment

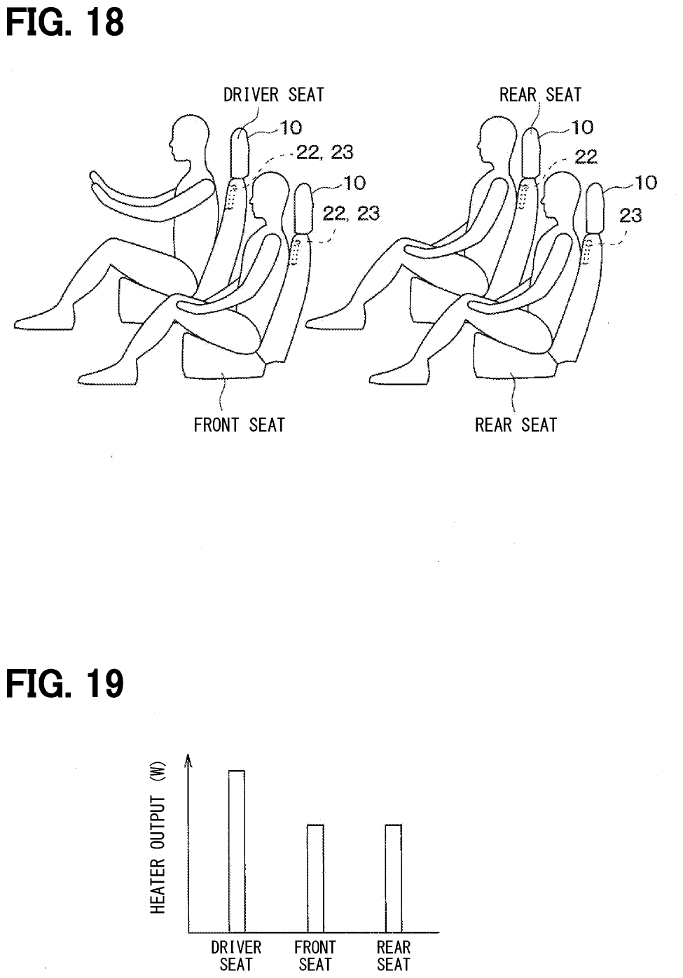

As shown in FIG. 18, in a seat heater of a sixth embodiment, each of a driving seat 10, a front seat 10, and two rear seats 10 has the radiant heaters 22 and 23. The radiant heaters 22 and 23 of each of the seats 10 are connected to the controller 25. The seat heater includes the controller 25 configured to control the radiant heaters.

The controller 25 of the present embodiment is configured to vary the output of the radiant heaters 22 and 23 according to the seats 10. Specifically, as shown in FIG. 19, the controller 25 is configured to control the radiant heater disposed in the driving seat to operate with a power consumption greater than a power consumption of the radiant heater disposed in the seats other than the driving seat. Thus, a passenger seated on the driving seat who tends to lean forward can feel a sufficient heat.

The present embodiment can achieve the effects and advantages, which are obtained from the structure common to the first embodiment.

The seat heater of the present embodiment includes the controller 25 configured to control the radiant heater. The controller 25 is configured to set the power consumption of the radiant heater disposed in the driving seat 10 to a value greater than the power consumption of the radiant heater disposed in the seats 10 other than the driving seat 10.

The passenger seated on the driving seat 10 is more likely to lean forward than the passengers seated on the seats 10 other than the driving seat 10 and tend to be contactless with the driving seat 10.

However, as described above, the radiant heaters 22 and 23 are controlled such that the power consumption of the radiant heaters 22 and 23 disposed in the driving seat 10 is greater than the power consumption of the radiant heater 22 and 23 disposed in the seats 10 other than the driving seat 10. Thus, the passenger seating on the driving seat 10 who tends to lean forward can feel a sufficient heat.

### Other Embodiments

(1) In the above described embodiments, the radiant heaters 21 to 24 are disposed in the recessed portion recessed from a surface of the seatback 12 in the thickness direction of the seatback 12. However, the radiant heaters 21 to 24 are not necessarily disposed in the recessed portion.

(2) In the first embodiment, the radiant heater 21 is disposed above the uppermost lateral hanging portion 123a disposed in the seatback 12 in the vertical direction. However, the radiant heater 21 may be disposed in an upper end portion of the seatback 12. In addition, the radiant heater 21 may be disposed in a position along an upper end of the seatback 12.

(3) The seat heater of the above described embodiments includes the heat generating portion 202 having a plate shape. In contrast, for example, like a device disclosed in JP 2014-003000 A, the seat heater may include a heat generating portion configured to suppress a temperature increase at a contact portion of the device with an object when the object is in contact with a surface of the device.

(4) In the above described embodiments, the protecting member 204 defining the through holes 204a formed into a honeycomb shape is described. However, the protecting member 204 may have a mesh shape.

(5) In the second embodiment, each of the right seat 10 and the left seat 10 includes the radiant heaters 22 and 23. In contrast, the right seat 10 and the left seat 10 may be connected to each other and configured as a whole.

(6) In the second embodiment, each of the right seat 10 and the left seat 10 includes the radiant heaters 22 and 23. In contrast, one seat 10 may be provided near a window located on a side of the center of the vehicle in the width direction.

In this case, the one seat 10 includes the radiant heater disposed in a portion of the seat 10 near the window in the width direction and the radiant heater disposed in a portion of the seat 10 near the other window in the width direction.

In the multiple radiant heaters, the power consumption of the radiant heater disposed in the portion of the seat 10 near the one window in the width direction is controlled to operate with a power consumption greater than that of the radiant heater disposed in the portion of the seat 10 near the other window in the width direction.

The present disclosure is not limited to the above-described embodiments, and can be appropriately modified. Individual elements or features of a particular embodiment are generally not limited to that particular embodiment, but, where applicable, are interchangeable and can be used in a selected embodiment, even if not specifically shown or described. Further, in each of the above-mentioned embodiments, it goes without saying that components of the embodiment are not necessarily essential except for a case in which the components are particularly clearly specified as essential components, a case in which the components are clearly considered in principle as essential components, and the like. A quantity, a value, an amount, a range, or the like, if specified in the above-described example embodiments, is not necessarily limited to the specific value, amount, range, or the like unless it is specifically stated that the value, amount, range, or the like is necessarily the specific value, amount, range, or the like, or unless the value, amount, range, or the like is obviously necessary to be the specific value, amount, range, or the like in principle. Further, in each of the embodiments described above, when materials, shapes, positional relationships, and the like, of the components and the like, are mentioned, they are not limited to these materials, shapes, positional relationships, and the like, unless otherwise specified and unless limited to specific materials, shapes, positional relationships, and the like.

### Overview

According to a first aspect shown in a portion or all portions of the embodiments, a seat heater is configured to heat the passenger seated on the seat disposed in the vehicle. The seat heater includes a radiant heater that is disposed in an area of the seat that is not in contact with the passenger seated on the seat. The radiant heater is configured to radiate a radiant heat toward the passenger seated on the seat.

According to a second aspect, the seat includes a recessed portion recessed from a surface of the seat. The radiant heater is disposed in a portion recessed from the surface of the seat defined by the recessed portion.

Thus, the passenger can be heated by the radiant heat radiated by the radiant heater without touching the radiant heater.

According to a third aspect, the seat includes a headrest configured to support the back of the head of the passenger. The radiant heater is disposed in an area of the seat located outside of both ends of the headrest in the width direction.

As described above, the radiant heater can be arranged in the area of the seat outside of the both ends of the headrest in the width direction. The passenger can be heated in the lateral direction.

According to a fourth aspect, the seat includes a seatback configured to support the back of the passenger. The seatback includes multiple linear lateral hanging portions extending in the width direction of the vehicle. The radiant heater is disposed above the uppermost one of the lateral hanging portions.

As described above, the radiant heater can be arranged above the uppermost one of the lateral hanging portions. As a result, shoulders of the passenger are restricted from easily touching the radiant heater and an upper portion of the back of the passenger can be heated. In addition, a blood flow between a neck and shoulders of the passenger is expected to be improved.

According to a fifth embodiment, the seatback includes multiple linear longitudinal hanging portions extending in the up-down direction. The radiant heater is disposed outside of the multiple longitudinal hanging portions in the width direction.

As described above, the radiant heater can be arranged outside of the multiple longitudinal hanging portions in the width direction. The passenger can be heated in the lateral direction.

According to a sixth aspect, the seat heater includes multiple radiant heaters at different positions of the seat. In this way, the multiple radiant heaters are provided at different positions.

According to a seventh aspect, the right seat disposed near the left window includes a radiant heater disposed in a right side portion of the seat in the width direction and a radiant heater disposed in a left side portion of the seat in the width direction.

In the multiple radiant heaters, a power consumption of the radiant heater disposed in the right side portion of the seat in the width direction is set to a value larger than a power consumption of the radiant heater disposed in the left side portion of the seat in the width direction.

Therefore, even if the cold air enters into the vehicle through the right window, the passenger can be efficiently heated.

According to an eighth aspect, the left seat disposed near the left window includes a radiant heater disposed in a left side portion of the seat in the width direction and a radiant heater disposed in a right side portion of the seat in the width direction.

In the multiple radiant heaters, a power consumption of the radiant heater disposed in the left side portion of the seat in the width direction is set to a value larger than a power consumption of the radiant heater disposed in the right side portion of the seat in the width direction.

Thus, even if the cold air enters into the vehicle through the left window, the passenger can be efficiently heated.

According to a ninth aspect, the seat heater includes a heating element and a controller. The heating element is configured to heat the passenger in a heating manner different from a heating manner of the radiant heater and the controller is configured to control the heating element and the radiant heater.

The controller is configured to control the radiant heater to operate with a power consumption lower than that of the heating element for a predetermined period after starting an operation of the radiant heater and the heating element. After that, the controller is configured to control the heating element to operate with a power consumption lower than that of the radiant heater.

Thus, the power consumption of the radiant heater and the power consumption of the heating element can be uniform, which saves the power. In addition, the load of the power supply that supplies electricity to the radiant heater and the heating element can be reduced.

According to a tenth aspect, the seat heater includes an inside temperature detector configured to detect a temperature in the vehicle cabin and a controller configured to control the radiant heater. The controller is configured to suppress the power consumption of the radiant heater as the inside temperature of the vehicle detected by the inside temperature detector increases. Therefore, unnecessary power consumption can be avoided.

According to an eleventh aspect, the seat heater includes an angle detector configured to detect a reclining angle of the seatback and a controller configured to control the radiant heater. The radiant heater is disposed in the seatback. The controller is configured to suppress the power consumption of the radiant heater upon determining the reclining angle of the seatback detected by the angle detector is greater than the predetermined angle.

When the reclining angle of the seatback is large, a distance between the passenger and the radiant heater tends to be short and the passenger may feel an excessive heat.

However, as described above, the controller is configured to suppress the power consumption of the radiant heater upon determining the reclining angle of the seatback detected by the angle detector is greater than the predetermined angle.

Thus, the passenger is restricted from feeling an excessive heat when the reclining angle of the seatback is large. In addition, unnecessary power consumption of the radiant heater can be avoided.

According to a twelfth aspect, the seat heater includes a controller configured to control a radiant heater. The controller is configured to control the radiant heater disposed in the driving seat to operate with a power consumption that is larger than that of the radiant heater disposed in a seat other than the driving seat.

The passenger seated on the driving seat tends to lean forward compared to the passenger seated on the seat other than the driving seat, so that the passenger seated on the driving seat is less likely to be in contact with the seat.

As described above, the radiant heaters are controlled such that the power consumption of the radiant heater disposed in the driving seat is larger than the power consumption of the radiant heater disposed in the seat other than the driving seat. Therefore, the passenger seated on the driving seat who tends to lean forward can feel an enough heat.

What is claimed is:

1. A seat heater configured to heat a passenger seated on a seat disposed in a vehicle, the seat heater comprising
a radiant heater configured to radiate a radiant heat toward the passenger seated on the seat, the radiant heater being disposed in an area of the seat that is not in contact with the passenger seated on the seat, wherein
the seat includes a seatback configured to support a back of the passenger,
the seatback has a plurality of linear lateral hanging portions extending in a width direction of the vehicle, and
the radiant heater is disposed above the most upper one of the plurality of liner lateral hanging portions in a vertical direction of the vehicle.

2. The seat heater according to claim 1, wherein
the seat includes a recessed portion recessed from a surface of the seat, and
the radiant heater is disposed in the recessed portion.

3. The seat heater according to claim 1, wherein
the seat has a headrest configured to support a back of a head of the passenger, and
the radiant heater is disposed in an area of the seat that is located outside of both ends of the headrest in the width direction of the vehicle.

4. The seat heater according to claim 1, wherein
the seatback has a plurality of linear longitudinal hanging portions extending in the vertical direction, and
the radiant heater is disposed outside of the plurality of linear longitudinal hanging potions in the width direction.

5. The seat heater according to claim 1, wherein
the radiant heater includes a plurality of radiant heaters, and
the plurality of radiant heaters are disposed at different positions in the seat.

6. The seat heater according to claim 5, wherein
the seat is a right seat near a right window of the vehicle,
the plurality of radiant heaters include a right radiant heater disposed in a right side portion of the right seat in the width direction and a left radiant heater disposed in a left side portion of the right seat in the width direction, and
the right radiant heater disposed in the right side portion of the right seat is configured to consume power greater than that of the left radiant heater disposed in the left side portion of the right seat.

7. The seat heater according to claim 5, wherein
the seat is a left seat near a left window of the vehicle,
the plurality of radiant heaters include a right radiant heater disposed in a right side portion of the left seat in the width direction and a left radiant heater disposed in a left side portion of the left seat in the width direction, and
the left radiant heater disposed in the left side portion of the left seat is configured to consume power greater than that of the right radiant heater disposed in the right side portion of the left seat.

8. The seat heater according to claim 1, further comprising:
a heating element configured to heat the passenger in a heating manner that is different from a heating manner of the radiant heater; and
a controller configured to control the heating element and the radiant heater, wherein
the controller configured to:
control the radiant heater to operate with a power consumption lower than that of the heating element for a predetermined period after starting an operation of the radiant heater and the heating element; and then
control the heating element to operate with a power consumption lower than that of the radiant heater.

9. The seat heater according to claim 1, further comprising:
an inside temperature detector configured to detect an inside temperature of the vehicle; and
a controller configured to control the radiant heater, wherein
the controller is configured to control the radiant heater to reduce a power consumption of the radiant heater as the inside temperature of the vehicle detected by the inside temperature detector increases.

10. The seat heater according to claim 1, further comprising:
an angle detector configured to detect a reclining angle of the seatback of the seat; and
a controller configured to control the radiant heater, wherein
the radiant heater is disposed in the seatback, and
the controller is configured to control the radiant heater to reduce a power consumption of the radiant heater upon determining that the reclining angle of the seatback detected by the angle detector is greater than a predetermined angle.
